(19) United States
(12) Patent Application Publication
(10) Pub. No.: US 2023/0321536 A1
(43) Pub. Date: Oct. 12, 2023

(54) Controlling Movement of a Virtual Character in a Virtual Reality Environment

(71) Applicant: Telefonaktiebolaget LM Ericsson (publ), Stockholm (SE)

(72) Inventors: Alexander Hunt, Tygelsjö (SE); Pex Tufvesson, Lund (SE)

(21) Appl. No.: 18/020,785

(22) PCT Filed: Aug. 31, 2020
(86) PCT No.: PCT/EP2020/074172

§ 371 Date: Feb. 10, 2023

(51) Int. Cl. A63F 13/213; A63F 13/428; A63F 13/5258

(52) U.S. Cl. CPC A63F 13/5258; A63F 13/213; A63F 13/428; A63F 2300/1093; A63F 2300/5553

(57) ABSTRACT

A method for controlling movement of a virtual character in a virtual reality environment provided by a virtual reality device is disclosed. The virtual reality device comprising a motion tracker, wherein positions of the virtual character in the virtual reality environment correlate to positions of a user of the virtual reality device in a physical movement area. The method comprises obtaining positions of the virtual reality device in the physical movement area from the motion tracker, determining positions of the virtual character in the virtual reality environment based on the obtained positions of the virtual reality device in the physical movement area, and controlling movement of the virtual character in the virtual reality environment by applying the determined positions in a movement of the virtual character in relation to a position C in the physical movement area. Corresponding computer program product, apparatus, and virtual reality headset are also disclosed.

### TECHNICAL FIELD

The present disclosure relates generally to the field of virtual reality. More particularly, it relates to controlling movement of a virtual character in a virtual reality environment.

### BACKGROUND

Typically, when playing a virtual reality game or experience a virtual reality world, a user moves around in a spacious physical area in order to play or experience the virtual reality game or the virtual reality world as intended. If the user does not have a lot of physical space, then the user needs different means to move around in the virtual reality game, e.g., via a teleport function or with a handheld controller.

A drawback of using a handheld controller, e.g., a joystick, for movement in a virtual reality environment is that the user may feel nausea.

A drawback of using a teleport function for movement in a virtual reality environment is that immersiveness of the virtual reality environment is broken or disturbed.

Therefore, there is a need for alternative approaches for controlling movement of a virtual character in a virtual reality environment.

### SUMMARY

It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an apparatus is referred to herein, it is to be understood as a physical product. The physical product may comprise one or more parts, such as controlling circuitry in the form of one or more controllers, one or more processors, or the like.

According to known technology, some attempts have been made to control movement of a virtual character in a virtual reality environment.

WO97/42620 describes a VR system where a controller allows the user to move a certain distance in the real world so that movement in the VR environment feels more natural. There are specified areas where different activities are performed where different sensors on the floor trigger a movement a specific distance in the VR environment.

US2010/0281438 is a vision based system detecting movements and gestures performed by the user in the real world and translating them into movement and actions performed in a gaming space shown on a screen.

It is an object of some embodiments to solve or mitigate, alleviate, or eliminate at least some of the above or other drawbacks.

According to a first aspect, this is achieved by a method for controlling movement of a virtual character in a virtual reality environment provided by a virtual reality device comprising a motion tracker, wherein positions of the virtual character in the virtual reality environment correlate to positions of a user of the virtual reality device in a physical movement area.

The method comprises obtaining positions of the virtual reality device in the physical movement area from the motion tracker, and determining positions of the virtual character in the virtual reality environment based on the obtained positions of the virtual reality device in the physical movement area.

The method further comprises controlling movement of the virtual character in the virtual reality environment by applying the determined positions in a movement of the virtual character in relation to a position C in the physical movement area.

In some embodiments, the method further comprises determining direction and velocity of the virtual character in the virtual reality environment based on the obtained positions of the virtual reality device in the physical movement area.

In some embodiments, the method further comprises defining boundaries of the physical movement area, wherein the physical movement area is restricted in space, and determining the position C within the boundaries of the physical movement area.

In some embodiments, the method further comprises obtaining angular positions and/or angular velocity of the virtual reality device in the physical movement area from the motion tracker.

In some embodiments, above method steps are performed continuously for continuously controlling movement of the virtual character in the virtual reality environment.

In some embodiments, determining the positions of the virtual character in the virtual reality environment is further based on the obtained angular positions and/or angular velocity.

In some embodiments, determining the direction and velocity of the virtual character in the virtual reality environment comprises calculating a vector based on a velocity algorithm.

In some embodiments, the determined velocity increases with an increasing distance from the position C in the physical movement area towards the boundary of the physical movement area.

In some embodiments, the determined velocity increases linearly.

In some embodiments, the determined velocity increases according to an acceleration mode.

In some embodiments, the determined velocity corresponds to a maximum velocity when the user reaches the boundary of the physical movement area.

In some embodiments, the motion tracker is configured to measure position and velocity of the virtual reality device in one or more degrees of freedom.

In some embodiments, the one or more degrees of freedom comprises six degrees of freedom, 6DoF.

In some embodiments, 6DoF comprises any one of moving left and right on the X-axis, moving up and down on the Y-axis, moving forward and backward on the Z-axis, tilting side to side on the Z-axis, tilting forward and backward on the X-axis, and turning left and right on the Y-axis.

In some embodiments, the motion tracker comprises an inertial measurement unit configured to measure and report any one of: specific force of the body, angular rate of the body, and orientation of the body.

In some embodiments, applying the determined positions in the movement of the virtual character is performed on a two-dimensional surface and/or in a three-dimensional space.

In some embodiments, the virtual reality device is configured to be mounted on the user’s head.

A second aspect is a computer program product comprising a non-transitory computer readable medium, having thereon a computer program comprising program instructions. The computer program is loadable into a data processing unit and configured to cause execution of the method according to the first aspect when the computer program is run by the data processing unit.

A third aspect is an apparatus for controlling movement of a virtual character in a virtual reality environment provided by a virtual reality device comprising a motion tracker, wherein positions of the virtual character in the virtual reality environment correlate to positions of a user of the virtual reality device in a physical movement area.

The apparatus comprises a controller configured to cause obtainment of positions of the virtual reality device in the physical movement area from the motion tracker, and determination of positions of the virtual character in the virtual reality environment based on the obtained positions of the virtual reality device in the physical movement area.

The controller is further configured to cause control of movement of the virtual character in the virtual reality environment by applying the determined positions in a movement of the virtual character in relation to a position C in the physical movement area.

In some embodiments, the controller is further configured to cause determination of direction and velocity of the virtual character in the virtual reality environment based on the obtained positions of the virtual reality device in the physical movement area.

In some embodiments, the controller is further configured to cause definition of boundaries of the physical movement area, wherein the physical movement area is restricted in space, and determination of the position C within the boundaries of the physical movement area.

In some embodiments, the controller is further configured to cause obtainment of angular positions and/or angular velocity of the virtual reality device in the physical movement area from the motion tracker.

In some embodiments, any one action caused by the controller is performed continuously for continuously controlling movement of the virtual character in the virtual reality environment.

In some embodiments, determination of the positions of the virtual character in the virtual reality environment is further based on the obtained angular positions and/or angular velocity.

In some embodiments, determination of direction and velocity of the virtual character in the virtual reality environment comprises calculation of a vector based on a velocity algorithm.

In some embodiments, the determined velocity is increased with an increasing distance from the position C in the physical movement area towards the boundary of the physical movement area.

In some embodiments, the determined velocity is increased linearly.

In some embodiments, the determined velocity is increased according to an acceleration mode.

In some embodiments, the determined velocity corresponds to a maximum velocity when the user reaches the boundary of the physical movement area.

In some embodiments, the motion tracker is configured to measure position and velocity of the virtual reality device in one or more degrees of freedom.

In some embodiments, the one or more degrees of freedom comprises six degrees of freedom, 6DoF.

In some embodiments, 6DoF comprises any one of moving left and right on the X-axis, moving up and down on the Y-axis, moving forward and backward on the Z-axis, tilting side to side on the Z-axis, tilting forward and backward on the X-axis, and turning left and right on the Y-axis.

In some embodiments, the motion tracker comprises an inertial measurement unit configured to measure and report any one of: specific force of the body, angular rate of the body, and orientation of the body.

In some embodiments, applying the determined positions in the movement of the virtual character is performed on a two-dimensional surface and/or in a three-dimensional space.

In some embodiments, the virtual reality device is configured to be mounted on the user’s head.

In some embodiments, the apparatus is operably connected to a Central Processing Unit, CPU.

In some embodiments, the apparatus and/or the CPU are operably connected to a Graphics Processing Unit, GPU.

A fourth aspect is a virtual reality headset comprising the apparatus according to the third aspect.

Any of the above aspects may additionally have features identical with or corresponding to any of the various features as explained above for any of the other aspects.

An advantage of some embodiments is that alternative approaches for controlling movement of a virtual character in a virtual reality environment are provided.

An advantage of some embodiments is that handheld controllers are no longer needed for movement in a virtual reality environment.

An advantage of some embodiments is that nausea caused by visual stimulus and not corresponding to felt motion will be reduced, thus making longer virtual reality sessions feasible.

An advantage of some embodiments is that immersiveness of the virtual reality environment is maintained, thus making the virtual reality being perceived as correct and enables online gaming with others.

An advantage of some embodiments is that a spacious physical area is no longer needed in order to play or experience the virtual reality game or the virtual reality world as intended.

It should be noted that, even if embodiments are described herein in the context of virtual reality, some embodiments may be equally applicable and/or beneficial also in other contexts.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a flowchart illustrating example method steps according to some embodiments;

FIG. 2 is a schematic drawing illustrating an example area according to some embodiments;

FIG. 3a is a schematic drawing illustrating an example graph according to some embodiments;

FIG. 3b is a schematic drawing illustrating an example movement according to some embodiments;

FIG. 3c is a schematic drawing illustrating an example graph according to some embodiments;

FIG. 3d is a schematic drawing illustrating an example graph according to some embodiments;

FIG. 3e is a schematic drawing illustrating an example graph according to some embodiments;

FIG. 3f is a schematic drawing illustrating an example movement according to some embodiments;

FIG. 3g is a schematic drawing illustrating an example movement according to some embodiments;

FIG. 4 is a schematic block diagram illustrating an example apparatus according to some embodiments; and

FIG. 5 is a schematic drawing illustrating an example computer readable medium according to some embodiments.

### DETAILED DESCRIPTION

As already mentioned above, it should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

Generally, even if exemplification is made using a context of virtual reality, it should be noted that some embodiments are equally applicable in other contexts, e.g., augmented reality (AR), mixed reality (MR), and extended reality (XR).

In the following, embodiments will be presented where alternative approaches for controlling movement of a virtual character in a virtual reality environment are described.

Virtual reality device, as described herein, may typically comprise a device operably connected to controlling circuitry configured to render virtual reality (VR) environments.

For example, a virtual reality device may be a virtual reality device headset mountable on a viewer’s head, wherein the virtual reality device headset comprises an optical element, a display, and a motion tracker.

Movement, as described herein, may typically comprise a change of position(s) in distance and/or azimuth angle and/or altitude angle.

For example, a movement of the virtual reality device may be caused by the user wearing the virtual reality device, e.g., by standing still and looking up/left/right or by jumping or by moving forward etc.

Physical movement area, as described herein, may typically comprise a physical area to move around in for experiencing a virtual reality environment, wherein the physical movement area is restricted in physical space.

Virtual reality environment, as described herein, may typically comprise projection of one or more images to render a virtual reality scene comprising virtual objects in virtual space.

It should be noted that, even if embodiments are described herein in the context of virtual reality, some embodiments may be equally applicable and/or beneficial also in other contexts such as of AR, MR, and XR.

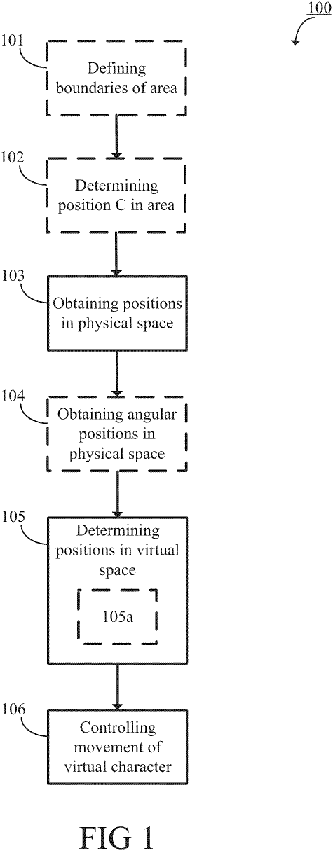

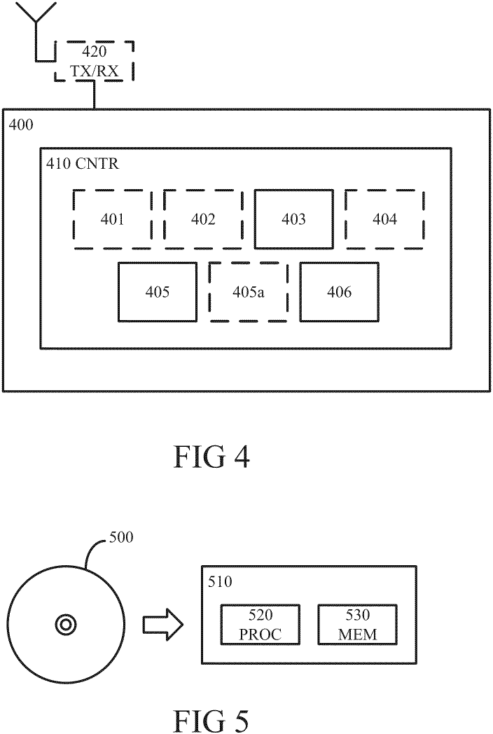

FIG. 1 is a flowchart illustrating method steps of an example method 100 according to some embodiments. The method 100 is for controlling movement of a virtual character in a virtual reality environment provided by a virtual reality device comprising a motion tracker, wherein positions of the virtual character in the virtual reality environment correlate to positions of a user of the virtual reality device in a physical movement area. Thus, the method 100 (or steps thereof) may, for example, be performed by apparatus 400 and/or controller 410 of FIG. 4; of which will be described later herein.

The method 100 comprises the following steps.

In optional step 101, in some embodiments, boundaries of the physical movement area are defined, wherein the physical movement area is restricted in space.

In some embodiments, the physical movement area comprises an area wherein boundaries of the area have been defined before-hand by a user, e.g., a user defines the boundaries by walking around in a room with a controller pointing to the floor and painting the boundary of the area to form an area, i.e., virtually drawing up the area.

In some embodiments, the physical movement area comprises an area wherein boundaries of the area have been specified as a minimum area by the virtual reality game or virtual reality world in order to be able to experience the full-immersive virtual reality environment.

For example, in some embodiments, a physical movement area of just 20 square meters may suffice to provide the full-immersion virtual reality environment.

In contrast, in prior art, a full-immersion experience of a virtual reality environment, e.g., a virtual arena, wherein a user freely moves over a spacious area, may require a physical movement area of about 60 square meters.

In optional step 102, in some embodiments, the position C is determined within the boundaries of the physical movement area.

In some embodiments, the position C may be determined at any position within the boundaries of the physical movement area.

Alternatively or additionally, the position C may be determined at a position within the boundaries of the physical movement area based on the size and the shape of the physical movement area as well as the type of virtual reality environment which is to be rendered and the type of movements the virtual character performs.

For example, in a virtual reality environment wherein the virtual character mostly moves forward, e.g., walking straight ahead, the point C may be determined close to a boundary of the physical movement area so that the maximum radius is as large as possible.

For example, in a virtual reality environment wherein the virtual character mostly moves in azimuth angle, e.g., when walking on a 2D surface, the point C may be determined to be in the centre of the physical movement area so that the largest possible circle is chosen around the point C with the longest distance possible for the physical movement area.

Alternatively or additionally, the position C may be determined by the user of the virtual reality device before starting the rendering of the virtual reality environment.

Alternatively or additionally, the position C may be determined by the device based on the type of virtual reality environment, e.g., the virtual reality game or the virtual reality world, in order to be able to experience the full-immersive virtual reality environment.

In step 103, positions of the virtual reality device in the physical movement area are obtained from the motion tracker.

In some embodiments, the motion tracker is configured to measure position and velocity of the virtual reality device in one or more degrees of freedom.

In some embodiments, the one or more degrees of freedom comprises six degrees of freedom, 6DoF.

For example, 6DoF comprises any one of moving left and right on the X-axis, moving up and down on the Y-axis, moving forward and backward on the Z-axis, tilting side to side on the Z-axis, i.e., roll - moving the head toward left or right shoulder (rotating around the Z-axis), tilting forward and backward on the X-axis, i.e., pitch - looking up and down with the head (rotating around the X-axis), and turning left and right on the Y-axis, i.e., yaw - looking to the right or to the left (rotating around the Y-axis).

In some embodiments, the motion tracker comprises an inertial measurement unit configured to measure and report any one of: specific force of the body, angular rate of the body, and orientation of the body.

For example, the motion tracker may track that the user is moving in a forward direction towards the boundary of the physical movement area at a certain velocity by obtaining at least two positions of the virtual reality device in movement.

Alternatively or additionally, an acceleration may also be determined based on the obtained positions or the virtual reality device in movement.

Alternatively or additionally, step 103 is performed continuously for controlling movement of the virtual character in the virtual reality environment.

In optional step 104, in some embodiments, angular positions and/or angular velocity of the virtual reality device in the physical movement area are obtained from the motion tracker.

For example, a user looking up in an altitude angle and jumping up at a certain angular velocity may be tracked.

For example, a user looking in an azimuth angle and turning around at a certain angular velocity may also be tracked.

Alternatively or additionally, step 104 is performed continuously for controlling movement of the virtual character in the virtual reality environment.

In step 105, positions of the virtual character in the virtual reality environment are determined based on the obtained positions of the virtual reality device in the physical movement area.

In some embodiments, the determining of the positions of the virtual character in the virtual reality environment is further based on the obtained angular positions and/or angular velocity.

For example, a user moving quickly forward while looking over the shoulder may also be tracked.

Alternatively or additionally, step 105 is performed continuously for controlling movement of the virtual character in the virtual reality environment.

In optional step 105a, in some embodiments, determining the direction and velocity of the virtual character in the virtual reality environment comprises calculating a vector based on a velocity algorithm, e.g., a velocity algorithm corresponding to the virtual reality environment.

Alternatively or additionally, step 105a is performed continuously for controlling movement of the virtual character in the virtual reality environment.

In step 106, movement of the virtual character in the virtual reality environment is controlled by applying the determined positions in a movement of the virtual character in relation to a position C in the physical movement area.

In some embodiments, applying the determined positions in the movement of the virtual character is performed on a two-dimensional surface and/or in a three-dimensional space.

Alternatively or additionally, step 106 is performed continuously for controlling movement of the virtual character in the virtual reality environment.

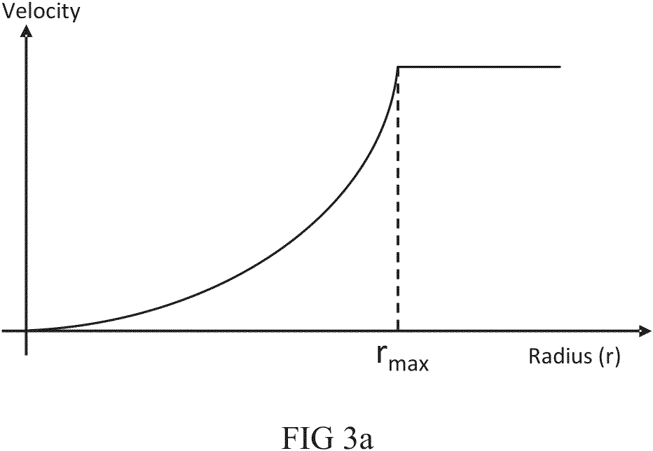

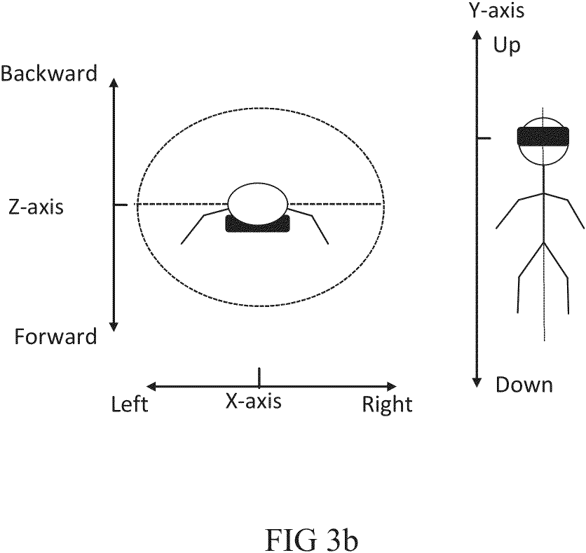

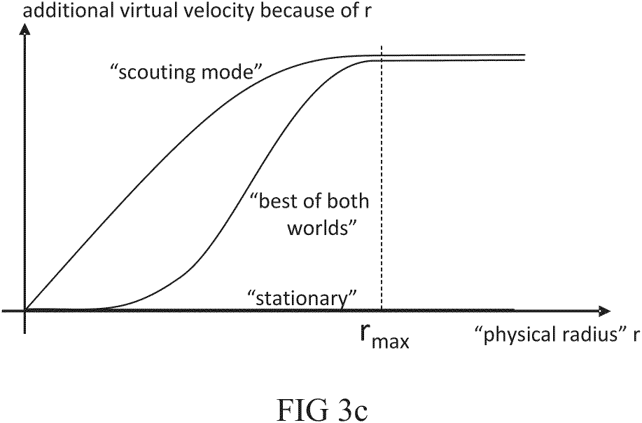

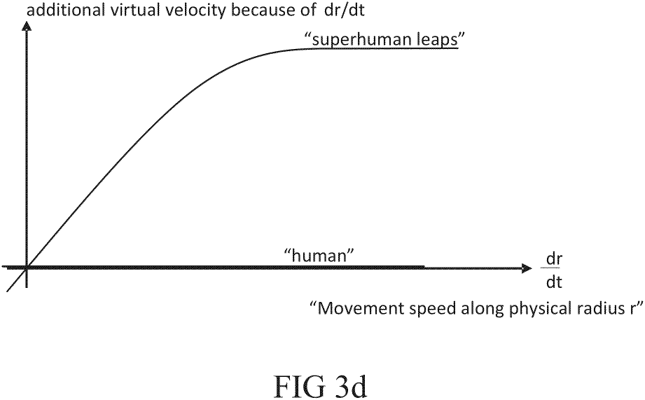

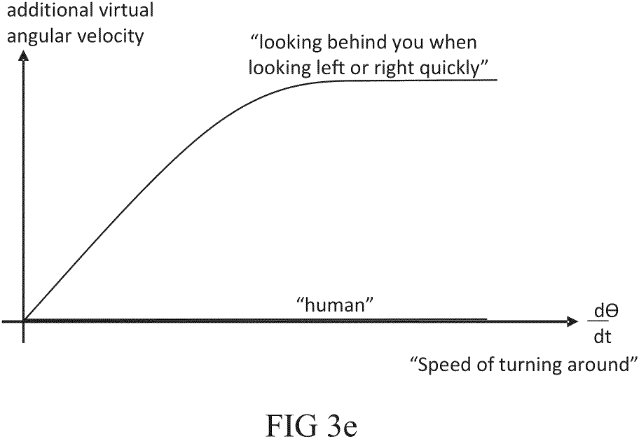

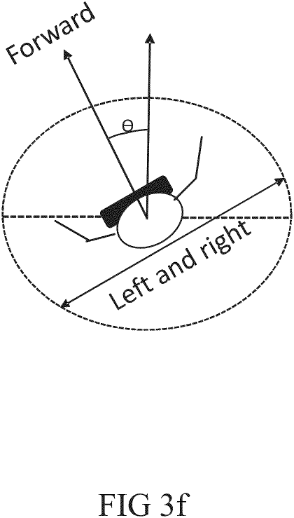

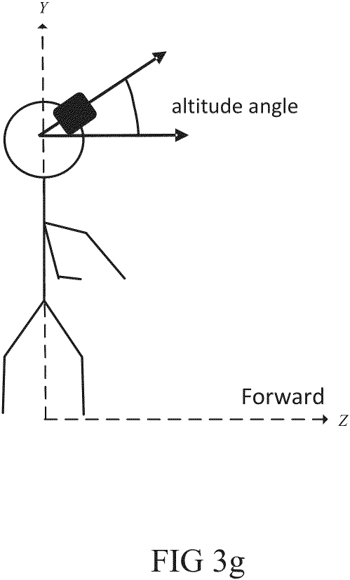

In some embodiments, the determined velocity increases with an increasing distance from the position C in the physical movement area towards the boundary of the physical movement area (reference to FIG. 3a).

In some embodiments, the determined velocity increases linearly (reference to FIG. 3b).

In some embodiments, the determined velocity increases according to an acceleration mode (reference to FIG. 3c).

In some embodiments, the determined velocity corresponds to a maximum velocity when the user reaches the boundary of the physical movement area (reference to FIGS. 3a-b).

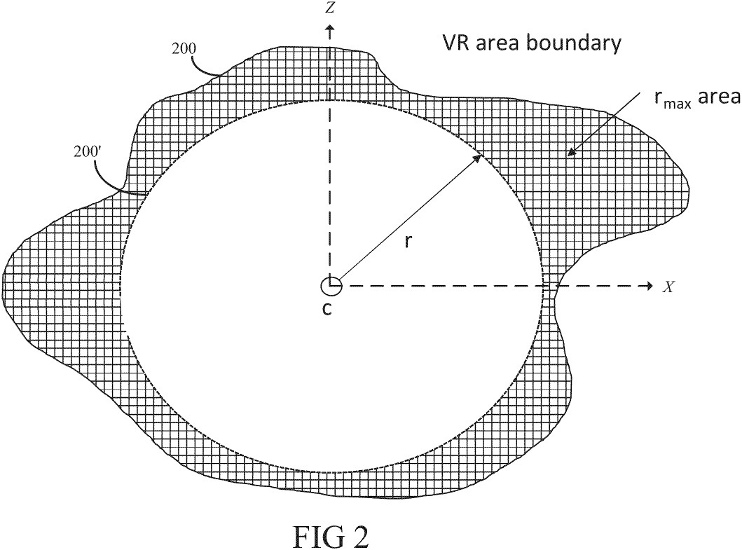

Any of the above steps for FIG. 1 may additionally have features which are identical with or corresponding to any of the various features as explained below for FIGS. 2-5 as suitable.

FIG. 2 is a schematic drawing illustrating an example area 200 according to some embodiments. The area 200 is for controlling movement of a virtual character in a virtual reality environment provided by a virtual reality device comprising a motion tracker, wherein positions of the virtual character in the virtual reality environment correlate to positions of a user of the virtual reality device in a physical movement area.

FIG. 2 illustrates a physical movement area 200 which has been defined by boundaries, i.e., a virtual reality (VR) boundary.

The physical movement area 200 defines a maximum area, i.e., a physical space available for a user in a specific physical environment, e.g., a room, which may be utilized for experiencing an immersive virtual reality environment.

In the physical movement area 200, a position C may be defined. The position C may be defined anywhere within the physical movement area 200 as described above in connection with FIG. 1.

For example, the point C may be defined to coordinates (0,0,0). In the y direction, it is the height position of the virtual reality device, e.g., a head-mounted display (HMD), that sets the 0 coordinate.

When the user of the virtual reality device is moving away from the defined position C in the x and z direction in the physical movement area 200, an algorithm is applied to the new position (x,y,z) and to the new viewpoint of the user. The application of the algorithm causes the user to move in a virtual reality environment with a certain continuous velocity, wherein positions of the virtual character correlate to positions of the user in the physical movement area 200.

In one embodiment, the algorithm may be a linear algorithm and the farther the user moves from the point C in the physical movement area 200, the faster the continuous velocity will be in the virtual reality environment in that direction from the point C.

In the physical movement area 200, a VR boundary area may be defined, as mentioned above.

The VR boundary area 200′ is illustrated as a circular area with a vector r that indicates the direction and velocity of the user in a virtual space.

As the user moves away from point C within the VR boundary area 200′, the velocity of the virtual character in a certain direction will increase. At a certain distance from point C, more specifically the distance to the area outside the VR boundary area 200′, the velocity will correspond to maximum velocity, rmax.

For example, when the user moves away from point C in a certain direction, a vector is calculated based on a velocity algorithm.

The user may move away from point C in one or more degrees of freedom. For example, the user may move in any one of X, Y, and Z directions as well as Roll, Yaw, and Pitch within the VR boundary area 200′.

Hence, it is the position of the HMD that will decide what position and velocity the user has in the virtual reality environment.

FIG. 3a is a schematic drawing illustrating an example graph according to some embodiments.

FIG. 3a illustrates a curve indicative of the user’s physical position and velocity which is correlated, i.e., translated, into a virtual position and velocity, and wherein the velocity in rmax is set by the application (reference to FIG. 2).

FIG. 3b is a schematic drawing illustrating an example movement according to some embodiments.

FIG. 3b illustrates a movement of the HMD which is worn by the user, e.g., left and right and forward, may be calculated by one or more sensors. The one or more sensors may comprise sensors configured to sense movements such as internal cameras, external cameras, inertial measurement unit (IMU), gyro, internal or external range measurements or a combination of different sensors. The calculations of HMD movement are not tied to the technologies mentioned above.

The position of the HMD determines movements. More specifically, it is the physical positions of the HMD in the physical movement area that decide the virtual positions and velocity of the virtual character together with the velocity of the physical movement, if that applies.

FIG. 3c is a schematic drawing illustrating an example graph according to some embodiments.

FIG. 3c illustrates curves indicative of the user’s physical position and velocity which is correlated, i.e., translated, into a virtual position and additional velocity because of r, and wherein the velocity in rmax is set by the application (reference to FIG. 2).

FIG. 3c illustrates a first curve “stationary”, wherein movement within the VR boundary area 200′ is a 1:1 relation to movement in the virtual reality environment, but it is also limited to this area and if the user want to move further away, another mean of movement is needed such as teleportation or joystick movement.

The stationary mode could be dynamically toggled if the application would benefit from such movement, i.e., the user enters a room in a virtual reality game that is the same area or adjusted to the same size as the VR boundary area 200′, then the stationary mode may be enabled.

FIG. 3c illustrates a second curve “scouting”, wherein movement within the VR boundary area 200′ is translated into a linear increase of the velocity in the direction of the vector from the point C. This could be useful for scouting a virtual reality gaming world or a virtual reality map where there is no use to have some freedom of moving close to the point C in the VR boundary area 200′.

The maximum virtual velocity is reached when a certain distance from point C in the physical movement area is reached, i.e., when the user has passed the VR boundary area 200′. Hence, when reaching the maximum virtual velocity depends on the size and form of physical movement area 200 (reference to FIG. 2).

FIG. 3c illustrates a third curve “best of both worlds”, wherein movement is within a reduced VR boundary area 200′ and close to the point C in the physical movement area 200 and wherein the virtual velocity change is very small. By adding this part, it will be easier to find the point C in the physical world without getting unwanted virtual movement, it also give the user a virtual work area in an application where there is no or very little velocity added. Moving further away from point C, the velocity will increase in a non-linear scale until the user reaches rmax.

Hence, with increasing distance by the user to the point C in the physical movement area 200, the velocity of the virtual character in the virtual reality environment will increase according to a set curve “best of both worlds”.

The illustrated curves may vary depending on the application at hand. Alternatively or additionally, an application programmer may decide on the curves adaptively throughout an application. For example, in a game application when moving around on large areas, one curve may apply, and once the virtual character is entering a building, another curve may be applied.

Alternatively or additionally, movements of the user in the physical movement area 200 may be combined with expected movements in the virtual reality environment.

FIG. 3d is a schematic drawing illustrating an example graph according to some embodiments.

FIG. 3d illustrates curves indicative of the user’s physical position and velocity which is correlated, i.e., translated, into a virtual position and additional velocity because of dr/dt.

In some applications, the acceleration of the user in the physical movement area 200 may be added onto the velocity in virtual reality environment as discussed above.

FIG. 3d illustrates a first curve “human”, wherein actual movement within the VR boundary area 200′ is translated, i.e., reflected, in the virtual reality environment as in the normal world, and there is no addition to the velocity by moving fast in one direction (high acceleration in one direction).

Following equation illustrates velocity in the virtual reality environment based on velocity due to physical movement, as well as position in the physical movement area 200.

$${V}_{v i r t u a l \text{} \_ \text{} s p a c e} = {V}_{p h y s i c a l \text{} \_ \text{} s p a c e} + {V}_{b e c a u s e \text{} \_ \text{} o f \text{} \_ \text{} r}$$

Velocity in the virtual reality environment is based on the velocity in the physical movement area 200, plus velocity gained from the distance from point C in the physical movement area 200.

FIG. 3d illustrates a second curve “superhuman leaps”, wherein acceleration of the user may be added as velocity increase in certain applications where one would like to give the user superhuman movement capabilities.

In the mode called “superhuman leaps”, an additional virtual velocity is added to the total velocity based on the physical speed the user is moving in. The acceleration could both be positive and negative, e.g., adding velocity or subtracting velocity.

Following equation illustrates velocity due to physical movement, and position in the in the physical movement area 200, as well as additional velocity due to velocity in the physical movement area 200.

$${V}_{v i r t u a l \text{} \_ \text{} s p a c e} = {V}_{p h y s i c a l \text{} \_ \text{} s p a c e} + {V}_{b e c a u s e \text{} \_ \text{} o f \text{} \_ \text{} r} + {V}_{b e c a u s e \text{} \_ \text{} o f \text{} \_ \text{} d r / d t}$$

Alternatively or additionally, movements of the user in the physical movement area 200 may be combined with expected movements in the virtual reality environment.

FIG. 3e is a schematic drawing illustrating an example graph according to some embodiments.

FIG. 3e illustrates curves indicative of the user’s physical position and angular velocity which is correlated, i.e., translated, into a virtual position and additional virtual angular velocity because of dΘ/dt.

In some applications, the acceleration of the user in the physical movement area 200 may be added onto the velocity in virtual reality environment as discussed above.

FIG. 3e illustrates a first curve “human”, wherein actual movement within the VR boundary area 200 is translated, i.e., reflected, in the virtual reality environment as in the normal world, and there is no addition to the angular velocity by moving fast in one angle direction (high acceleration in one angle). Hence, angular velocity is not added to the movement velocity and it is possible to look in one direction and move in another direction, just as in real life.

FIG. 3e illustrates a second curve “looking behind you when looking left or right quickly”, wherein an acceleration part is added to the angular velocity so that you may “look behind you” in a virtual reality environment without turning the head the full 180 degrees. This mode may be used, for example, in first person shooter games like Counterstrike.

Following equation illustrates angular velocity in the virtual reality environment due to physical movement, as well as additional angular velocity due to velocity of turning around in the physical movement area 200.

$${V}_{\text{θ} \text{} \_ \text{} v i r t u a l \text{} \_ \text{} w o r l d} = {V}_{\text{θ} \text{} \_ \text{} p h y s i c a l \text{} \_ \text{} w o r l d} + {V}_{\text{θ} \text{} \_ \text{} b e c a u s e \text{} \_ \text{} o f \text{} \_ \text{} d \text{θ} / d t}$$

FIG. 3f is a schematic drawing illustrating an example movement according to some embodiments.

For example, in a virtual reality environment application where a vehicle you are controlling should have additional inertness, like driving a heavy tank with a turret or controlling a boat, you want the user to be able to quickly look around, while the vehicle or vessel is slowly turning towards the direction of the user’s physical angle. In the example of a tank with a turret, the tank might be turning even slower than the turret.

FIG. 3g is a schematic drawing illustrating an example movement according to some embodiments.

In a 3D space, the altitude angle in the virtual reality environment is used without modification in a 2D movement on a surface scenario.

When the application wants to give the user free movement in the virtual 3D space, then the altitude angle is used in the physical environment together with the additional velocity in the virtual reality environment due to r in the physical movement area 200, as described above.

This is useful when the application has a part where you navigate under water, in the air, or in space, with for instance vessels like airplanes, space shuttles, rockets, submarines or gliders etc.

When the user controls heavier vessels, the virtual altitude angle will slowly turn towards the user’s physical altitude angle. When controlling small or light vessels, the virtual altitude angle will be the same as the user’s physical altitude angle.

The velocity in the Y direction in the virtual reality environment, corresponding to up and down, will be determined by:

$$\begin{matrix}{V}_{Y \text{} \_ \text{} v i r t u a l \text{} \_ \text{} s p a c e} = {V}_{Y \text{} \_ \text{} p h y s i c a l \text{} \_ \text{} s p a c e} + \\ sin \left(v i r t u a l \text{} \_ \text{} a l t i t u d e \text{} \_ \text{} a n g l e\right) ∗ \left({V}_{b e c a u s e \text{} \_ \text{} o f \text{} \_ \text{} r} + {V}_{b e c a u s e \text{} \_ \text{} o f \text{} \_ \text{} d r / d t}\right)\end{matrix}$$

Hence, the upwards and downwards velocity in the virtual reality environment is based on the upwards and downwards velocity due to physical movement, as well as virtual altitude angle combined with x-z-position in the physical space and additional velocity due to x-y-velocity in the physical space.

Alternatively or additionally, movements of the user in the physical movement area 200 may be combined with expected movements in the virtual reality environment.

FIG. 4 is a schematic block diagram illustrating an example apparatus 400 according to some embodiments. The apparatus 400 is for controlling movement of a virtual character in a virtual reality environment provided by a virtual reality device comprising a motion tracker, wherein positions of the virtual character in the virtual reality environment correlate to positions of a user of the virtual reality device in a physical movement area. Thus, the apparatus 400 and/or the controller 410 may, for example, perform one or more method steps of FIG. 1 and/or one or more steps otherwise described herein.

The apparatus 400 comprises a controller 410 configured to cause obtainment of positions of the virtual reality device in the physical movement area from the motion tracker, and determination of positions of the virtual character in the virtual reality environment based on the obtained positions of the virtual reality device in the physical movement area.

The controller 410 is further configured to cause control of movement of the virtual character in the virtual reality environment by applying the determined positions in a movement of the virtual character in relation to a position C in the physical movement area.

In some embodiments, the controller 410 is furthermore configured to cause determination of direction and velocity of the virtual character in the virtual reality environment based on the obtained positions of the virtual reality device in the physical movement area.

In some embodiments, the controller 410 is furthermore configured to cause definition of boundaries of the physical movement area, wherein the physical movement area is restricted in space, and determination of the position C within the boundaries of the physical movement area.

In some embodiments, the controller 410 is furthermore configured to cause obtainment of angular positions and/or angular velocity of the virtual reality device in the physical movement area from the motion tracker.

The apparatus 400 may, as mentioned above, comprise the controller 410 (CNTR; e.g., control circuitry or a controlling module), which may in turn comprise, (or be otherwise associated with; e.g., connected or connectable to), an obtainer 403, e.g., obtaining circuitry or obtaining module, configured to obtain positions of the virtual reality device in the physical movement area from the motion tracker (compare with step 103 of FIG. 1).

The controller 410 further comprises, (or is otherwise associated with; e.g., connected or connectable to), a determiner 405, e.g., determining circuitry or determining module, configured to determine positions of the virtual character in the virtual reality environment based on the obtained positions of the virtual reality device in the physical movement area (compare with step 105 of FIG. 1).

The controller 410 further comprises, (or is otherwise associated with; e.g., connected or connectable to), a controller 406, e.g., controlling circuitry or controlling module, configured to control movement of the virtual character in the virtual reality environment by applying the determined positions in a movement of the virtual character in relation to a position C in the physical movement area (compare with step 106 of FIG. 1).

In some embodiments, the controller 410 furthermore comprises, (or is otherwise associated with; e.g., connected or connectable to), a definer 401, e.g., defining circuitry or defining module, configured to define boundaries of the physical movement area, wherein the physical movement area is restricted in space (compare with step 101 of FIG. 1).

In some embodiments, the controller 410 furthermore comprises, (or is otherwise associated with; e.g., connected or connectable to), a determiner 402, e.g., determining circuitry or determining module, configured to determine the position C within the boundaries of the physical movement area (compare with step 102 of FIG. 1).

In some embodiments, the controller 410 furthermore comprises, (or is otherwise associated with; e.g., connected or connectable to), a obtainer 404, e.g., obtaining circuitry or obtaining module, configured to obtain angular positions and/or angular velocity of the virtual reality device in the physical movement area from the motion tracker (compare with step 104 of FIG. 1).

In some embodiments, the controller 410 furthermore comprises, (or is otherwise associated with; e.g., connected or connectable to), a determiner 405a, e.g., determining circuitry or determining module, configured to determine direction and velocity of the virtual character in the virtual reality environment based on the obtained positions of the virtual reality device in the physical movement area (compare with step 105a of FIG. 1).

In some embodiments, the controller 410 furthermore comprises, (or is otherwise associated with; e.g., connected or connectable to), a transceiver TX/RX 420, e.g., transceiving circuitry or transceiving module, configured to transmit and receive information related to a virtual reality environment in a wireless communication network.

In some embodiments, the apparatus 400 and/or the controller 410 is completely or partially comprised in a virtual reality device operably connected to controlling circuitry, e.g. a motion tracker, configured to track movements of a user wearing the virtual reality device.

In some embodiments, the apparatus 400 and/or the controller 410 is completely or partially comprised in in a cloud environment.

Generally, when an apparatus is referred to herein, it is to be understood as a physical product. The physical product may comprise one or more parts, such as controlling circuitry in the form of one or more controllers, one or more processors, or the like.

The described embodiments and their equivalents may be realized in software or hardware or a combination thereof. The embodiments may be performed by general purpose circuitry. Examples of general purpose circuitry include digital signal processors (DSP), central processing units (CPU), Graphics Processing Units (GPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a wireless communication device.

Embodiments may appear within an electronic apparatus (such as a wireless communication device) comprising arrangements, circuitry, and/or logic according to any of the embodiments described herein. Alternatively or additionally, an electronic apparatus (such as a wireless communication device) may be configured to perform methods according to any of the embodiments described herein.

According to some embodiments, a computer program product comprises a computer readable medium such as, for example a universal serial bus (USB) memory, a plug-in card, an embedded drive or a read only memory (ROM).

FIG. 5 illustrates an example computer readable medium in the form of a compact disc (CD) ROM 500. The computer readable medium has stored thereon a computer program comprising program instructions. The computer program is loadable into a data processor (PROC) 520, which may, for example, be comprised in a wireless communication device 810. When loaded into the data processor, the computer program may be stored in a memory (MEM) 530 associated with or comprised in the data processor.

In some embodiments, the computer program may, when loaded into and run by the data processing unit, cause execution of one or more method steps according to, for example, FIG. 1 and/or one or more of any steps otherwise described herein.

In some embodiments, the computer program may, when loaded into and run by the data processing unit, cause execution of steps according to, for example, FIG. 1 and/or one or more of any steps otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1-38. (canceled)

39. A method for controlling movement of a virtual character in a virtual reality environment provided by a virtual reality device comprising a motion tracker, wherein positions of the virtual character in the virtual reality environment correlate to positions of a user of the virtual reality device in a physical movement area, the method comprising :
obtaining positions of the virtual reality device in the physical movement area from the motion tracker;
determining positions, direction, and velocity of the virtual character in the virtual reality environment based on the obtained positions of the virtual reality device in the physical movement area; and
controlling movement of the virtual character in the virtual reality environment by applying the determined positions in a movement of the virtual character in relation to a position C in the physical movement area.

40. The method according to any of claim 39, further comprising:
defining a boundary of the physical movement area, such that the physical movement area is restricted in space; and
determining the position C within the boundary of the physical movement area.

41. The method according to claim 40, wherein the determined velocity increases according to one or more of the following:
with an increasing distance from the position C in the physical movement area towards the boundary of the physical movement area; and
linearly or according to an acceleration mode.

42. The method according to claim 40, wherein the determined velocity corresponds to a maximum velocity when the user reaches the boundary of the physical movement area.

43. The method according to claim 39, wherein:
the method further comprises obtaining angular positions and/or angular velocity of the virtual reality device in the physical movement area from the motion tracker; and
determining the positions of the virtual character in the virtual reality environment is further based on the obtained angular positions and/or angular velocity.

44. The method according to claim 39, wherein the obtaining, determining, and controlling operations are performed repeatedly to effect continuous control of the movement of the virtual character in the virtual reality environment.

45. The method according to claim 39, wherein determining the direction and velocity of the virtual character in the virtual reality environment comprises calculating a vector based on a velocity algorithm.

46. The method according to claim 39, wherein the motion tracker is configured to measure position and velocity of the virtual reality device in one or more of the following degrees of freedom: moving left and right on the X-axis, moving up and down on the Y-axis, moving forward and backward on the Z-axis, tilting side to side on the Z-axis, tilting forward and backward on the X-axis, and turning left and right on the Y-axis.

47. The method according to claim 39, wherein the motion tracker comprises an inertial measurement unit configured to measure and report any one of: angular rate of the body, and orientation of the body.

48. The method according to claim 39, wherein applying the determined positions in the movement of the virtual character is performed on a two-dimensional surface and/or in a three-dimensional space.

49. The method according to claim 39, wherein the virtual reality device is configured to be mounted on the user’s head.

50. An apparatus arranged to control movement of a virtual character in a virtual reality environment provided by a virtual reality device comprising a motion tracker, wherein positions of the virtual character in the virtual reality environment correlate to positions of a user of the virtual reality device in a physical movement area, wherein the apparatus comprises a controller configured to cause the apparatus to:
obtain positions of the virtual reality device in the physical movement area from the motion tracker;
determine positions, direction, and velocity of the virtual character in the virtual reality environment based on the obtained positions of the virtual reality device in the physical movement area; and
control movement of the virtual character in the virtual reality environment by applying the determined positions in a movement of the virtual character in relation to a position C in the physical movement area.

51. The apparatus according to claim 50, the controller being further configured to cause the apparatus to:
define a boundary of the physical movement area, such that the physical movement area is restricted in space; and
determine the position C within the boundary of the physical movement area.

52. The apparatus according to claim 51, wherein the determined velocity increases according to one or more of the following:
with an increasing distance from the position C in the physical movement area towards the boundary of the physical movement area; and
linearly or according to an acceleration mode.

53. The apparatus according to claim 51, wherein the determined velocity corresponds to a maximum velocity when the user reaches the boundary of the physical movement area.

54. The apparatus according to claim 50, wherein the controller is further configured to cause the apparatus to:
obtain angular positions and/or angular velocity of the virtual reality device in the physical movement area from the motion tracker; and
determine the positions of the virtual character in the virtual reality environment further based on the obtained angular positions and/or angular velocity.

55. The apparatus according to claim 50, wherein the controller is further configured to cause the apparatus to perform the obtain, determine, and control operations repeatedly to effect continuous control of the movement of the virtual character in the virtual reality environment.

56. The apparatus according to claim 50, wherein the controller is further configured to cause the apparatus to determine direction and velocity of the virtual character in the virtual reality environment based on calculation of a vector based on a velocity algorithm.

57. The apparatus according to claim 50, wherein the motion tracker is configured to measure position and velocity of the virtual reality device in one or more of the following degrees of freedom: moving left and right on the X-axis, moving up and down on the Y-axis, moving forward and backward on the Z-axis, tilting side to side on the Z-axis, tilting forward and backward on the X-axis, and turning left and right on the Y-axis.

58. The apparatus according to claim 50, wherein the motion tracker comprises an inertial measurement unit configured to measure and report any one of: specific force of the body, angular rate of the body, and orientation of the body.

59. The apparatus according to claim 50, wherein the controller is further configured to cause the apparatus to apply the determined positions in the movement of the virtual character on a two-dimensional surface and/or in a three-dimensional space.

60. The apparatus according to claim 50, wherein the virtual reality device is configured to be mounted on the user’s head.

61. The apparatus according to claim 50, wherein the apparatus is operably connected to one or more of the following: a Central Processing Unit (CPU), and a Graphics Processing Unit (GPU).

62. A virtual reality headset comprising the apparatus according to claim 50.
